(19) United States
(12) Patent Application Publication
(10) Pub. No.: US 2022/0291412 A1
(43) Pub. Date: Sep. 15, 2022

(54) METAL DETECTING SENSOR ARRAY FOR DISCRIMINATING BETWEEN DIFFERENT OBJECTS

(71) Applicant: Christopher Frank Eckman, San Francisco, CA (US)

(72) Inventor: Christopher Frank Eckman, San Francisco, CA (US)

(21) Appl. No.: 17/693,728

(22) Filed: Mar. 14, 2022

Related U.S. Application Data
(60) Provisional application No. 63/160,451, filed on Mar. 12, 2021.

(51) Int. Cl. G01V 3/38; G06V 10/764; G06V 10/82; G01V 3/08

(52) U.S. Cl. CPC G01V 3/38; G06V 10/764; G06V 10/82; G01V 3/087

(57) ABSTRACT

A metal detector that uses a verity of sensors as input for a neural network to optimize discrimination and detection of known or unknown objects. The detector will also have employ an user defined frequencies that will help to create custom settings. The detector will be able to use the sweeping motion of the detector head to create many frames of reference for understanding the composition, depth, size, type, approximant length of time it had remained, and to some extent orientation of known/unknown objects. This will be fed back to a user who can help identify the object once it is found. If it is different or new, the user can enter what it was into a database that can be used to train signals for future use, such as through using the data for training and/or updating machine learning models which can be used to accurately identify object.

### CROSS-REFERENCE TO RELATED PATENT APPLICATIONS

This application claims the benefit of U.S. Provisional Application No. 63/160,451, filed Mar. 12, 2021, the contents of which are incorporated by reference herein.

### TECHNICAL FIELD

This document generally describes devices, systems, and methods related to metal detection and metal detectors. In particular, this document relates to new systems and methods for discrimination and detection of unknown objects within ground, rock, or other materials.

### BACKGROUND

Metal detectors have been used to detect or identify unknown objects within different materials, such as the ground and rocks. For example, metal detectors have often been constructed as handheld devices with a sensor probe that can be moved over the ground to generate signals that indicate the presence of metal below the surface. Such sensor probes have included, for example, an oscillator that produces alternating current passing through a coil that is waved over the ground to generate an alternating magnetic field. When the coil is passed over an object that includes electrically conductive metal, eddy currents are induced in the metal and produces a magnetic field of its own. A magnetometer, which is just one of several different types of devices that can be used to register magnetic fields, can be used to detect changes in the magnetic field caused by such a metallic object generating its own magnetic field. The output of the magnetometer can be provided to the user, for example, as an auditory tone that indicates the presence of a metallic object nearby. The magnetometer can also have receiver coils that allow for a signal to be returned and registered into an audio signal for the user. The magnetometer can also return the signal to the user via a display screen.

### SUMMARY

This document generally describes systems and methods for more accurate metal and object detection. The disclosed embodiments can be applied to terrestrial detection as well as detection on any other material, such as asteroids, moon, planets, etc. In some implementations, a portable device can locate unknown metal or magnetic field producing/reacting objects that may or may not be hidden due to being underneath soil, behind magnetically transparent material, or an object that is somehow obstructed from view. Using a magnetic camera in conjunction with a varied number of other sensors that feed a machine learning algorithm and/or neural network trained model, the portable device can more accurately locate the unknown metal or object(s).

One or more preferred embodiments can include a metal detecting apparatus for detecting metallic objects, the apparatus having a metal detecting device including a metal detecting sensor configured to provide a signal indicating a presence of a metallic object, at least one additional sensor that is different from the metal detecting sensor configured to output an additional signal related to detection of the metallic object, and a controller that is configured to receive the signal from the metal detecting sensor and the additional signal from the at least one additional sensor. The controller can perform operations that include receiving the signals, interpreting the signals using a trained machine learning model that correlates the signals to a plurality of different types of metallic objects, and outputting, to a user interface, the detection of the metallic object. The user interface can be configured to provide feedback to the user of the detection of the metallic object.

The preferred embodiments can include one or more of the following features. For example, the at least one additional sensor can be a 3-axis sensor configured to generate an image of a local magnetic field of the metallic object. The controller can also be configured to perform operations that include receiving the image of the local magnetic field, and identifying, based on the image of the local magnetic field, the metallic object. Identifying the metallic object can be based on determining a material of the metallic object, determining a size of the metallic object, determining a depth of the metallic object, and labeling the metallic object based on the material, size, and depth. Moreover, labeling the metallic object can include comparing one or more of the material, size, and depth of the metallic object to machine learning models of labeled objects stored in a database.

As another example, the at least one additional sensor can be an accelerometer that can be configured to detect at least one of a speed and a movement of the metal detecting device. The at least one additional sensor can also be a gyroscope that can be configured to detect an orientation of the metal detecting device. The at least one additional sensor can also be a temperature sensor that can be configured to detect a temperature of a surrounding environment of the metal detecting device. The at least one additional sensor can be a humidity sensor that can be configured to detect a humidity level of a surrounding environment of the metal detecting device. The at least one additional sensor can also be a pressure gauge that can be configured to detect a pressure level in a surrounding environment of the metal detecting device.

As yet another example, the at least one additional sensor can be a location sensor that can be configured to determine coordinates of the metal detecting device in a surrounding environment. The controller can also perform operations that further include receiving the coordinates of the metal detecting device, generating a map of the metal detecting device in the surrounding environment, storing the map in at least one of (i) a database in communication with the controller and (ii) memory of the controller, and outputting, based on user input received at the user interface, the map for display at the user interface.

As another example, the controller can perform operations that also include classifying the signals of the metallic object using a machine learning model of the metallic object, and iteratively training the machine learning model of the metallic object based on the classified signals. The trained machine learning model can be a deep neural network.

The controller can also perform operations that include receiving user input of a frequency of the signal from the metal detecting device, and classifying the signal from the metal detecting device based on the user input and the trained machine learning model. The controller can perform operations that include outputting a classification of the metallic object to the user interface. The controller can also perform operations that can include storing, in a database, at least one of (i) a classification of the metallic object, (ii) a classified signal from the metal detecting device, and (iii) a classified additional signal from the at least one additional sensor.

As additional examples, the controller can perform operations that include classifying metallic objects based on signals from the metal detecting device of the metallic object in a plurality of different surrounding environments. The controller can also perform operations further including classifying the metallic object based on user input. The user input can include at least one of a current location of the metal detecting device or an identification label of at least one metallic object.

Moreover, the at least one additional sensor can be at least one of a 3-axis sensor, an accelerometer, a gyroscope, a temperature sensor, a humidity sensor, a pressure gauge, or a location sensor. The at least one additional senor can include a 3-axis sensor, an accelerometer, a gyroscope, a temperature sensor, a humidity sensor, a pressure gauge, and a location sensor. The user interface can be in communication with the controller and can be configured to provide haptic feedback, a display, or audio output of the detection of the metallic object.

One or more advantages can be realized from the disclosed embodiments. For example, the disclosed technology can more accurately and precisely identify objects that are buried or otherwise detected within another material. Traditional metal detectors have only been able to generate signals that indicate the presence of a metallic object nearby with poor discrimination. The poor discrimination often leads to false positives and/or an inability to distinguish between different types of objects. However, the disclosed technology improves upon traditional metal detecting by being able to differentiate and distinguish between different types of objects, such as differentiating between different types of metals (e.g., gold, silver) that are present in the objects as well as being able to differentiate between different types of objects (e.g., coins, rings, tools, raw metals). The disclosed technology can provide output to users that identifies these determinations, such as texts, icons, auditory tones, haptic feedback, and/or other outputs that users can understand as distinguishing between different types of objects. Such output can not only improve the metal detecting experience for users, but it can also improve the efficiency of metal detecting by providing users with insightful and accurate information that can be used, for example, to determine whether to retrieve (e.g., dig up) the object that has been detected. Users may, for instance, only be interested in certain types of metals and/or in certain types of objects. The disclosed technology can help users in better decide when to expend the time and energy to retrieve objects that are of interest to the users.

In another example, the disclosed technology can provide for accurate identification of objects that are buried in the ground or otherwise contained within other materials. For example, through the use of additional sensors beyond those present in traditional metal detectors (e.g., such as inertial measurement unit (IMU) sensors, accelerometers, etc.) and the use of trained machine learning algorithms, the disclosed technology can identify objects with great accuracy. Such accurate object identification significantly improves over traditional metal detection, which provide for poor results, poor accuracy, and false positives in object differentiation.

In a further example, the disclosed technology can be extended to other uses beyond handheld metal detectors. For instance, the disclosed technology may be expanded and used in commercial settings, such as through mineral exploration, commercial mining, and/or other metal/object based retrieval operations.

In another example, the disclosed technology can be adaptable and robust, and can permit for accurate object identification regardless of materials in which objects are contained and/or other environmental factors. For instance, metallic objects may provide magnetic signatures that vary depending on the type of soil in which they are buried (e.g., clay, dirt, gravel) and/or based on environmental conditions (e.g., cold, heat, humidity). To avoid false identification of objects, the disclosed technology can detect soil and environmental conditions, including atmospheric and magnetic Earth fields that are fed into a machine learning model that has been trained across different soil and environmental conditions to permit for accurate identification of objects across a wide variety of soil and environmental conditions.

In a further example, the disclosed technology can permit for robust machine learning model generation and for continuous improvement of machine learning models. For example, the disclosed technology can be configured to obtain sensor readings across a variety of verified object, soil, and environmental conditions, and to use those to train robust and accurate machine learning models that can be used at run-time to accurately detect and differentiate among objects. Furthermore, the disclosed technology can permit for continuous improvement and refinement of trained models based on, for instance, sensor data obtained from users at run-time coupled with verified user object identification (both confirmation of object identification generated from machine learning model and correction of inaccurate identification). Such data and user verification can be provided to a server system for refinement of machine learning models, which can be updated and pushed out to metal detecting devices for use in detecting objects.

In yet another example, the disclosed technology can provide extensive feedback to the user to improve the user's ability to detect objects. The feedback can be generated using machine learning and other training techniques. Among various outputs, the feedback can include accelerometer information. The accelerometer information can assist the user in more accurately moving the detection device described herein. More accurate movement of the detection device can result in more accurate and faster locating of an object.

In another example, the disclosed technology permits for user customization of detection settings. The user can define settings such as frequencies and types of objects the user desires to locate. The user can also customize other settings to personalize the user's detection experience (e.g., information that is displayed on a display screen, a radius or geographic region to search in, etc.). As a result, the user can have a personalized experience and avoid spending time or effort identifying and detecting items of little to no interest to the user.

The details of one or more embodiments are set forth in the accompanying drawings and the description below. Other features and advantages will be apparent from the description and drawings, and from the claims.

### DESCRIPTION OF DRAWINGS

FIG. 1 depicts an example metal detector as described herein.

FIG. 2A depicts operation of a metal detection system as described herein.

FIG. 2B depicts training neural network models of the metal detection system.

FIG. 3 depicts a magnetic sensor array as a series of camera ‘pixels’ that build up a sensor.

FIG. 4 depicts information from sensors that contributes to a signal processed by a deep neural network of the metal detection system described herein.

FIG. 5 depicts the signal of FIG. 4 over time for an object.

FIG. 6A depicts a range of atmospheric and environmental factors that can affect the signal.

FIG. 6B depicts length of time as a factor that affects the signal.

FIG. 6C depicts a range of soil types that affect the signal.

FIG. 6D depicts a range of moisture content in soil that affect the signal.

FIG. 7 is a flowchart of a process for using the metal detection system described herein.

FIG. 8 is a flowchart of a process for training the metal detection system described herein.

### DETAILED DESCRIPTION

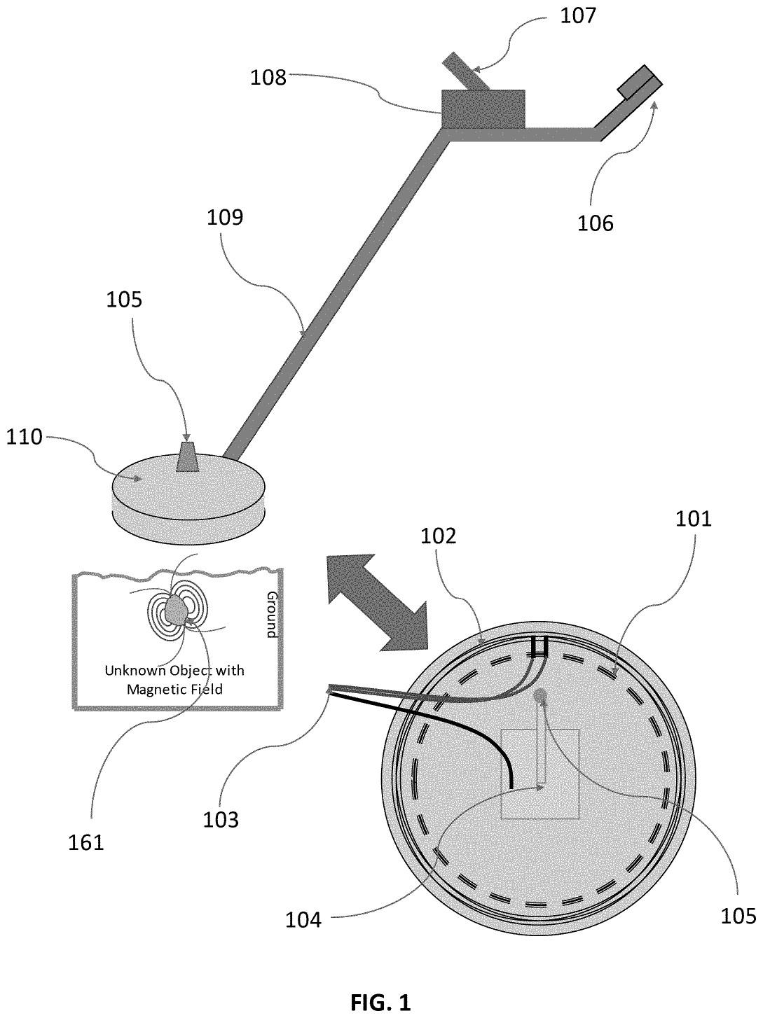

This document generally describes devices, systems, and methods related to more accurate metal detection. FIG. 1 depicts an example metal detector as described herein. The metal detector can have a conventional setup for holding the metal detector while standing, with a computer 108 and screen 107 located near a user's hand for ease of inputting or viewing output from the detector. A top end of the detector can have an arm support 106. A detector head 110 can be different as it may need room for a variety of sensors, coils, and housing that the head 110 can keep free from dirt and other elements in a surrounding environment. A non-ferrous or plastic shaft 109 can help support the detector head 110. The shaft can be made of a material that may not react to the detector head 110. Wires can run a length of the shaft 109. The wires can be configured to transmit signals to the processing computer 108. Moreover, an antenna 105 can be attached to the detector housing 104 and/or the detector head 110 or to the computer 108 of the detector. The antenna 105 can be configured to determine coordinates of the detector in a particular location.

A strategically placed faraday shield 101 can be used to buffer sensitive components of the metal detector from a magnetic field. This can also help ensure that signals from the unknown object 161 are being picked up by a magnetic sensor array 104. This can also help shield transmission and reception coils 102 from components of the detector and any signals. A variable frequency range for a magnetic field transmitting coil 102 can provide for the user to apply whatever frequency or frequencies the user desires. In some implementations, Radio Frequency (RF) can be used to apply a signal. The Radio Frequency waves can be induced by an antenna array (e.g., antenna 105). For example, a ground penetrating radar (GPR) can be used with an array of sensors to create more accurate representations of the object 161.

Moreover, the user can customize multiple channels to their preferred settings. A portable computing board (e.g., the computer 108) can make decisions and calculations and display such decisions and calculations at the screen 107. Therefore, the user can immediately review these decisions and calculations.

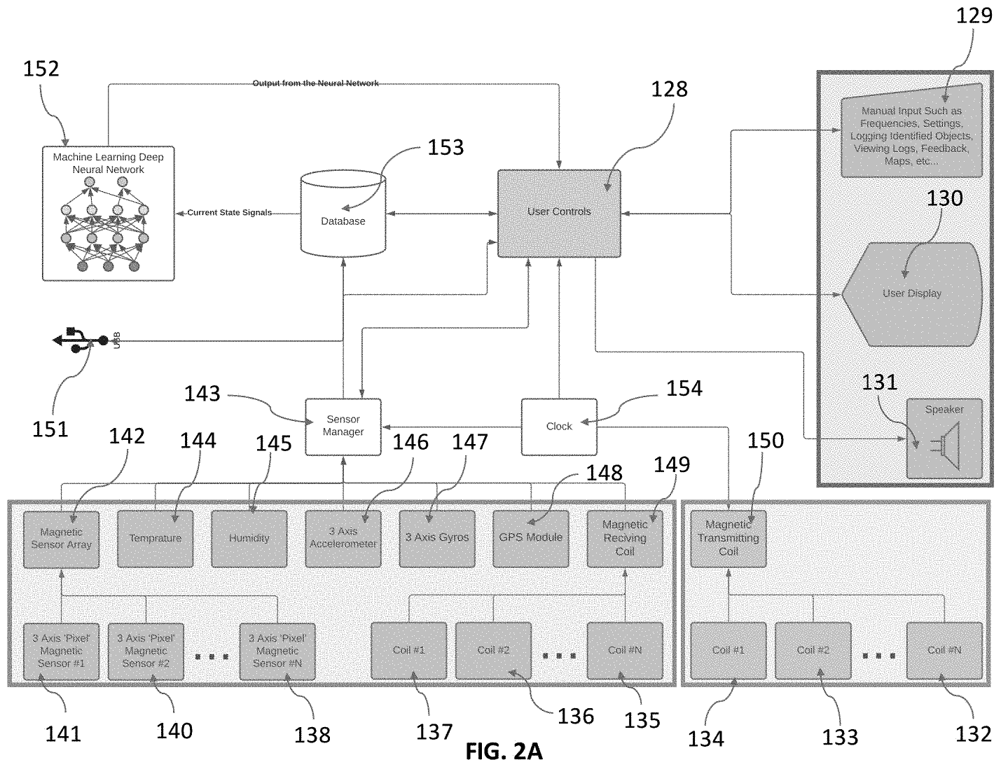

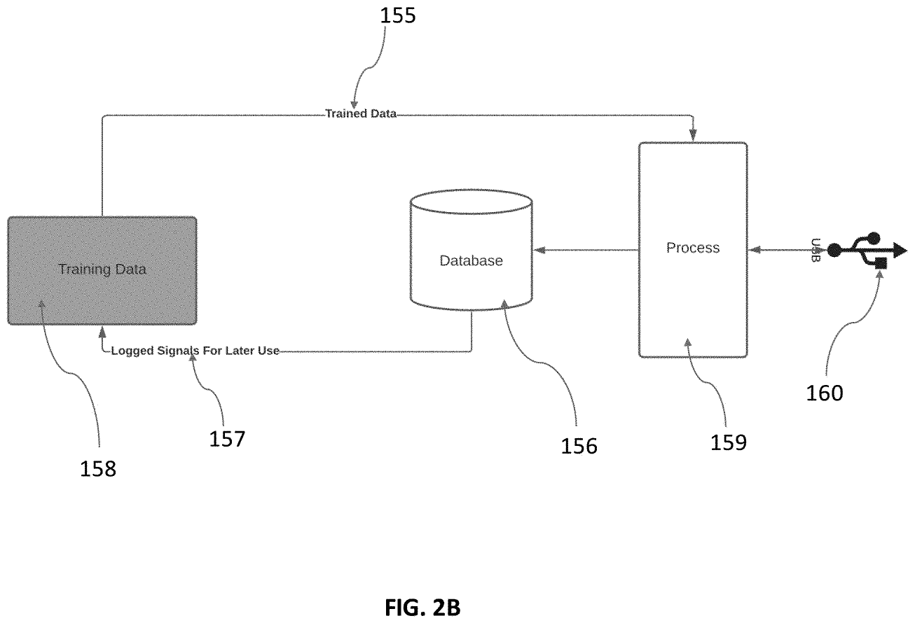

FIG. 2A depicts operation of a metal detection system as described herein. FIG. 2B depicts training neural network models of the metal detection system. Referring to both FIGS. 2A-B, a trained machine learning model 152 (e.g., neural network) can sift and sort through data collected by one or more sensors of the metal detector. The model 152 can determine a depth, size, material, and approximate orientation of an unknown object (e.g., unknown object 161 in FIG. 1). In addition, the model 152 can be trained to understand a local environment around the unknown object. This can be advantageous to provide for better understanding and discrimination of a soil type, load stone, and/or object under investigation.

Information such as a geographic location and user identification (somewhat or fully) of the unknown object that is being detected can be stored in a database 153. One or more additional data, such as original detection signals, can be stored in a database 156 (e.g., an external storage system), as depicted in FIG. 2B. The information stored in the databases 153 and 156 can be used as feedback and training into the metal detection system herein to improve detection accuracy and discrimination. A camera on the detector can optionally catalog findings for later reference and research by the computer 108. Moreover, detected signals and locations can be logged in the database 153 for further research and/or use, as described throughout this disclosure.

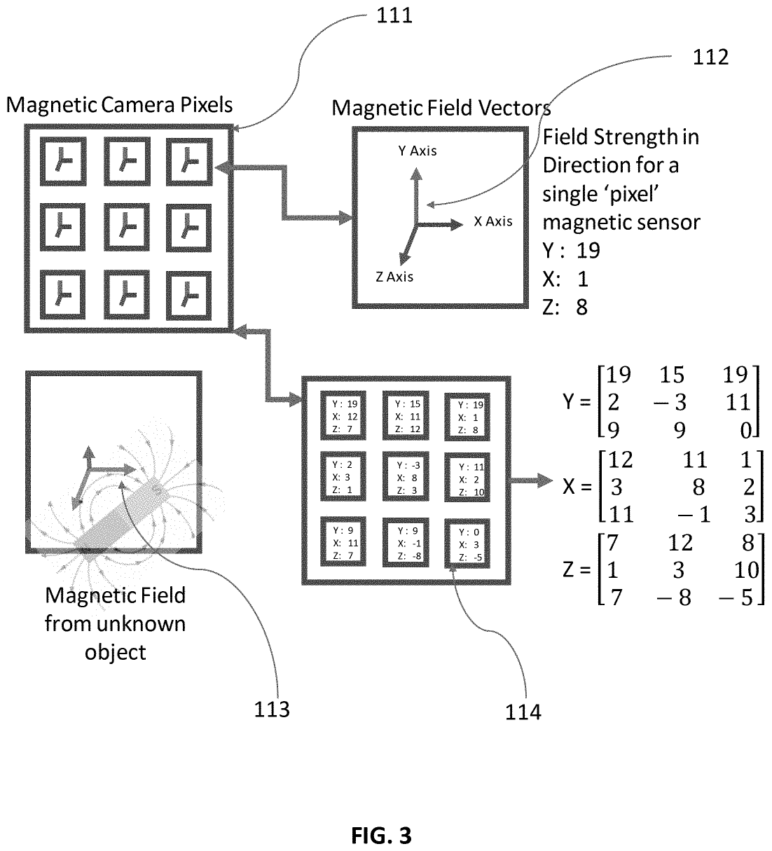

As depicted in FIG. 2A, the metal detector can have an array of 3-axis magnetic sensors (x, y, and z magnetic field orientations) 138, 140, and 141. These sensors 138, 140, and 141 can be hall effect sensors, magnetometers, magnetic sensing screens, and/or wire coils that create an array of magnetic ‘pixels’ within a reference image (e.g., refer to reference image 111 in FIG. 3). Such sensors 138, 140, and 141 can be managed by an internal sensor manager 143 that coordinates all signals and prepares them for the neural network 152.

An accelerator 146, gyroscope 147, magnetic compass 149, temperature sensor 144, pressure gauge (not depicted), and humidity sensor 145 can be attached to or proximate a magnetic sensor array 142. This can be similar to an Inertial Measurement Unit (IMU) gathering environmental data on the magnetic sensor array 142. This data can be presented with each magnetic sensor ‘image’ that is produced via a central timestamp of the metal detection system.

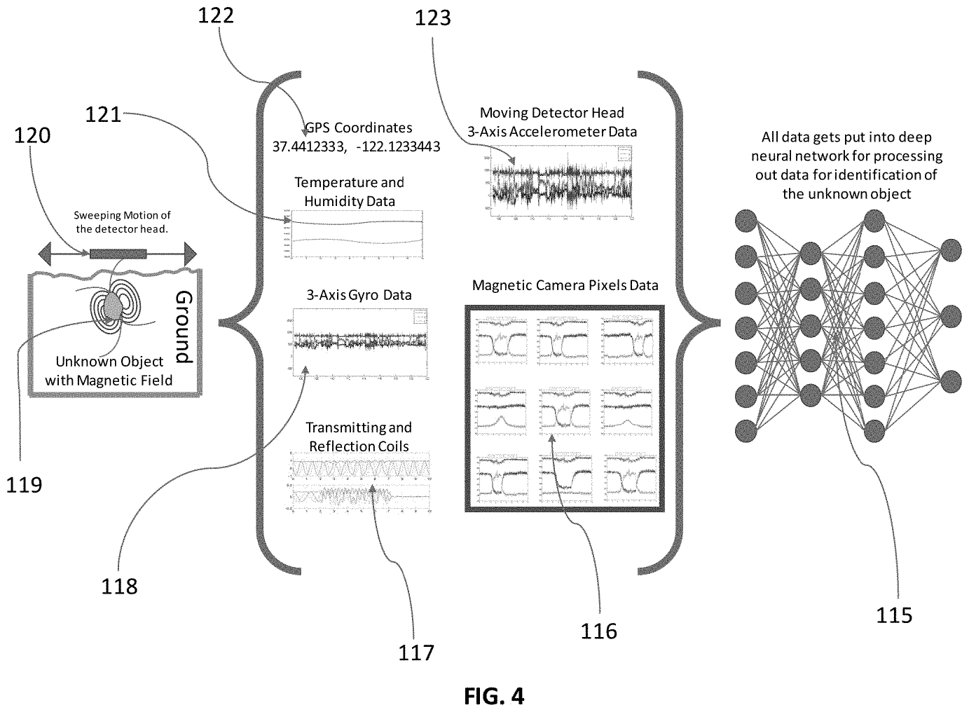

The 3-axis gyroscope 147 (e.g., refer to data 118 in FIG. 4) can be used to help determine orientation of the detector head with respect to a target object. Magnetic flux density can be a force per unit length per unit current on a current carrying a conductor at right angles to the magnetic field. The right angles can be required for the best coupling between a field and a detector sensor. Therefore, the gyroscope 147 can assist in determining a current angle of the detector head (e.g., refer to the detector head 110 in FIG. 1), which can remove variations in a signal due to inadequate handling of the detector head. As a result, the target signal and angle of the detector head can be accounted for with the gyroscope 147.

The magnetic compass 149 can also be used to indicate the Earth's magnetic field and can help identify any influence that the Earth's magnetic field may have on objects being detected. A local geographical magnetic field can have many variations and anomalies. The filed can change and morph in many ways. The magnetic compass 149, therefore, can help determine artifacts that may arise from the Earth's magnetic field or some overarching local magnetic field, manmade or natural, that can interfere with the target object's magnetic field.

The temperature sensor 144 (e.g., refer to data 121 in FIG. 4) can be positioned near or at the detector head to determine a temperature of a surrounding environment. Temperature can play a role in resistances of different materials' ability to conduct electricity. For example, free electrons in a metal are in constant random motion. As electrons move around, they collide with each other and with other atoms of the metal. In the presence of a magnetic field, the majority of electrons move in a current or flow as defined by electromagnetic interaction mathematics. Collisions of the electrons within the metal can impede their movement, which is known as resistance. If the temperature of the metal is increased, the atoms vibrate stronger and the electrons make more violent collisions. Thus, the resistance of the metal increases. The reverse is true as well, where the temperature drops, the resistance of the metal decreases. The resistance of a material affects the magnetic field produced by that material. By knowing the temperature of the local environment, using the temperature sensor 144, a relative drop or increase in the object's resistance can be determined.

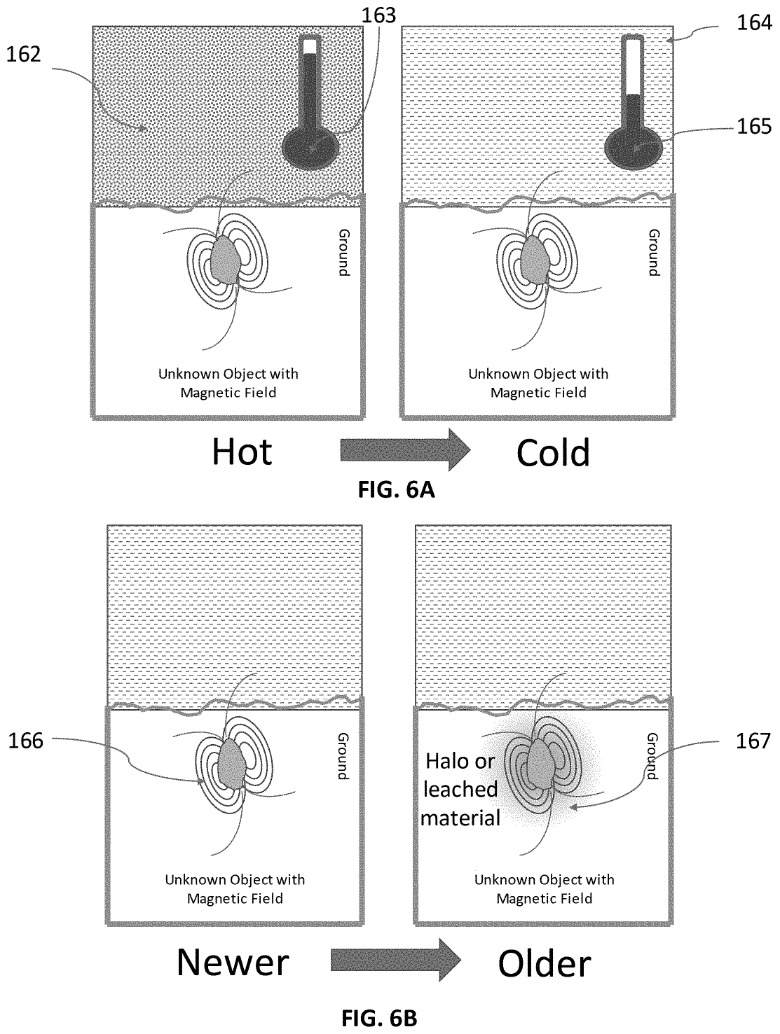

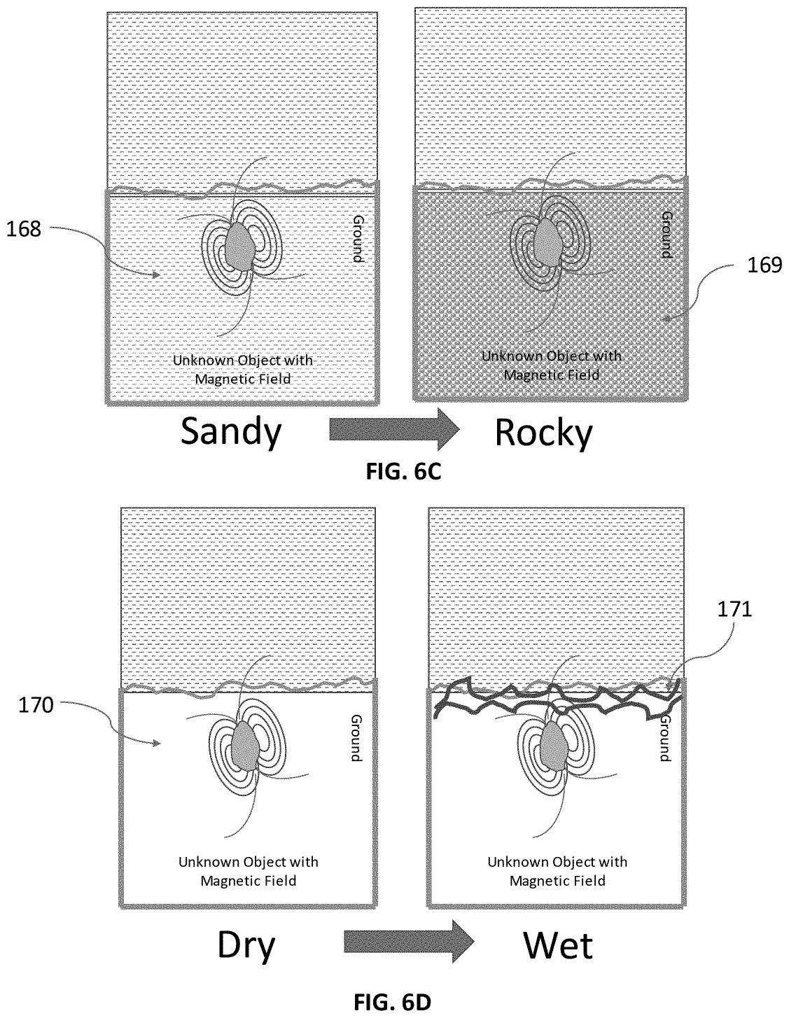

The humidity sensor 145 (e.g., refer to the data 121 in FIG. 4) can be attached to or near the magnetic sensor array (e.g., the magnetic sensor array 104 in FIG. 1, the magnetic sensor array 142 in FIG. 2A). The humidity sensor 145 can provide for determining how much moisture is in a surrounding environment (e.g., refer to FIG. 6A). An electric field strength, as well as magnetic flux density, can have optimized significant values at a higher temperature 163 and lower humidity and pressure of air 164, as depicted in FIG. 6A. For example, as humidity increases in air, there is an increase of scattering of electromagnetic waves. The humidity sensor 145 can measure humidity in order to assist the metal detection system described herein to take into account such scattering of electromagnetic waves.

As mentioned, the sensors 138, 140, 141, 142, 144, 145, 146, 147, 148, and/or 149 can be managed by the sensor manager 143 (e.g., internal software) and a clock 154 that can route signals generated by these sensors into the neural network 152 for processing. In addition, the signals can be saved into the database 153 for future reference and training. The sensor manager 143 can communicate with the clock 154 to ensure that input to the neural network 152 is proper and ready for calculation. The neural network 152 can then report to the user controls 128 and output feedback information or other information as audio 131 and/or visual signal(s) 130. The audio signal 131 can be a merger of various signals or a defined signal from user input 129. Therefore, unique signals for different objects can be outputted to help the user in identifying signals based only on audio 131.

A Global Positioning System (GPS) 148 (e.g., refer to the antenna 105 in FIG. 1, data 122 in FIG. 4) can determine coordinates, which can be logged as a representation of a position of the metal detection system in some geographical location. GPS coordinates and/or locations can be referenced by the neural network 152 to identify specifics about a geological makeup of some geographical location. Understanding the location's makeup from cross-referencing geological survey maps, for example, can assist the metal detection system in adjusting to compensate and balance signals with local makeup for improved accuracy.

As mentioned, the metal detection system can also recognize an area and help the user find new places to detect objects. Moreover, the system can display where signals had been located in the past. The system can maintain a log of where and what signals were used and/or located in the database 153. This log can be viewed by the user at a mobile device (e.g., laptop, smartphone, computer, tablet) and/or at the computer 108 of the metal detector. In some implementations, this log can be displayed in the form of a map.

Although not depicted, a pressure sensor and/or GPS coordinates can be used to cross-reference a known altitude for an output signal. As pressure increases, the electromagnetic waves can be more scattered. Therefore, by identifying pressure in the surrounding environment, the metal detector system can more accurately account for scattering of the electromagnetic waves (e.g., refer to FIG. 6A).

In addition to data from the magnetic sensor array 142, GPS 148, and the IMU (144-147 respectively), a setup, variant, or combination of a Very Low Frequency (VLF), Beat-Frequency Oscillation, Pulse Induction (PI), and/or some other magnetic field inducing method can also be fed into a data stream (e.g., for use by the neural network 152) as a signal over a period of time. Such additional data can be fed into the data stream based upon a trigger by the clock 154. The clock 154 can indicate a minimum time period of a signal and allow for groupings of outputs within a particular time. Having a specific time for all the signals can maintain uniformity, thereby ensuring calculations can be more accurate for that given time. In other words, using a known detection method or a combination of known methods, including but not limited to Very Low Frequency (VLF), Beat-Frequency Oscillation, Pulse Induction (PI), Transformer Coupled Oscillator (TCO), Coil Coupled Operation (CCO), or some other magnetic field inducing/detecting method with all the other signals can help further isolate and identify a target 132-134, 150, 102. Signals from a detection method can be used to help identify the object being detected and increase range and ability of the detector to identify the object.

Machine learning artificial intelligence (AI) can also automatically swap between various types of metal detector variants. VLF metal detectors can be advantageous in shallow targets or smaller targets. On the other hand, PI metal detectors can be better at penetrating heavily mineralized areas and finding a target. PI detectors can measure a rate of decay of a target signal over time, which sets PI detectors apart from the VLF detectors. The machine learning can be trained to determine a ground type, sensitivity of a received signal, and/or swap between different metal detector types in order to optimize identification, depth, and size of the target signal. The machine learning described herein may not be limited to two types of detection methods. Rather, the machine learning can mimic many different types of detector types over various frequencies, pulses, and/or continuous signals in a short amount of time in order to determine identification, depth, and size of the target.

Changing a frequency or mixing frequencies can be done manually or automatically using machine learning (e.g., at 128 and/or 129 of FIG. 2A). For example, the user can tune into a particular frequency or frequencies. This can include frequencies of the transmitting coils of the metal detector, where those frequencies are used to induce magnetic fields within a target. The user input 129 can tune such frequencies to whatever value(s) the user desires. Having such control can allow the user to create specific tuned modes within the detector to better target objects that the user is trying to identify. The user can save these user defined tunes (e.g., store at the database 153 in FIG. 2A) for specific locations and/or target objects using the user display 130. Default settings can also apply if the user does not want to control the tune of the detector.

A sweeping frequency, set frequency, and/or mixed frequencies can help determine attributes such as identification, depth, and size of the target. Higher frequencies may not penetrate the ground near as deep, but instead can find smaller targets. Lower frequencies can penetrate deep and find larger targets. By setting a sweeping frequency, set frequency, and/or mixed frequencies, manually or automatically, the metal detection system (e.g., the computer 108) can sort through a signal and responses to that signal to properly determine identification, depth, and size of the target. A return signal from the target can contain information about the target. This information can be fed into the neural network 152, which can be configured to classify signals into potential groups of signals. A label for the target can then be displayed to the user for review and/or correction (e.g., at user display 130 in FIG. 2A).

Another variant can be using Radio Frequency (RF) waves induced by an antenna array. Yet another variant can be using Ground Penetrating Radar signals. The user can tune into a particular frequency or frequencies that, like any other data, can be triggered by the clock 154. A received or return signal from the RF waves or GPR can then be formatted for induction of a machine learning algorithm or neural network 152, which can be trained from known signals.

Still referring to FIGS. 2A-B, the user of the metal detector can dig up the unknown object 161, identify it, and then enter the identified object(s) 161 into the metal detection system for training at a later time (e.g., refer to user controls 128 and/or the manual input 129 at the user display 130 in FIG. 2A). In some implementations, the user and/or the metal detection system can also include the Earth's magnetic field as a source of input 128 and/or 129. The neural network 152 can assess ground types using GPS coordinates 122, as depicted in FIG. 4. For example, the network 152 can determine a geolocation of a park, a mountainous region, and/or a city. Furthermore, the user can decide if they would like to share information about the identified object(s) 161 with a network of all metal detectors or keep such information encrypted for their use and training 151, 160.

A metal detector machine learning algorithm (e.g., the neural network 152) can utilize trained data and models 155 and 158 (e.g., refer to FIG. 2B), which can be loaded into the neural network 152, to identify one of more aspects of the data being detected from the unknown object 161. The computer 108 and/or a portable computer or device (e.g., a Raspberry Pi, Droid, Arduino, etc.) can be configured to run calculations on all inputted data 128. An onboard computer can be used for proper processing and maintenance of local databases. As an example, data measured by one or more of the sensors described herein can be formatted via the signal manager 143. Then, the neural network 152 (e.g., refer to the neural network 115 in FIG. 4) can be trained from known signals.

As mentioned, the Earth's magnetic field can be inputted into the neural network 152. Using the magnetic field of the Earth, the metal detection system described herein can have better resolution on the unknown target object. For example, rocks having desirable features, such as gold or other metals, can be detected using the disclosed technology. Analysis can then be performed to identify what materials the unknown target object is made from. Additionally or alternatively, geographical location information from the GPS module 148 can provide the user with the ability to return to a particular area and continue searching for more unknown objects. An application on a computing device can display a map (e.g., at the display 130, at a remote device such as a laptop or mobile phone, and/or at the display 107 of the computer 108) with marked areas where the user has been or areas that have already been searched. Such a display can also identify particular objects that were discovered, with an image and/or detection signals relating to the discovered objects.

FIG. 3 depicts a magnetic sensor array as a series of camera ‘pixels’ that build up a sensor. For example, the sensors 138, 140, and/or 142 can create the magnetic sensor array within a reference image. Analogous to a camera pixel array found in cameras, the magnetic array can produce a field orientation 113 given for each pixel along an array 112. These pixels can show an orientation of x, y, and z magnetic field strengths that can be represented in vector form 114 for all points within the image area.

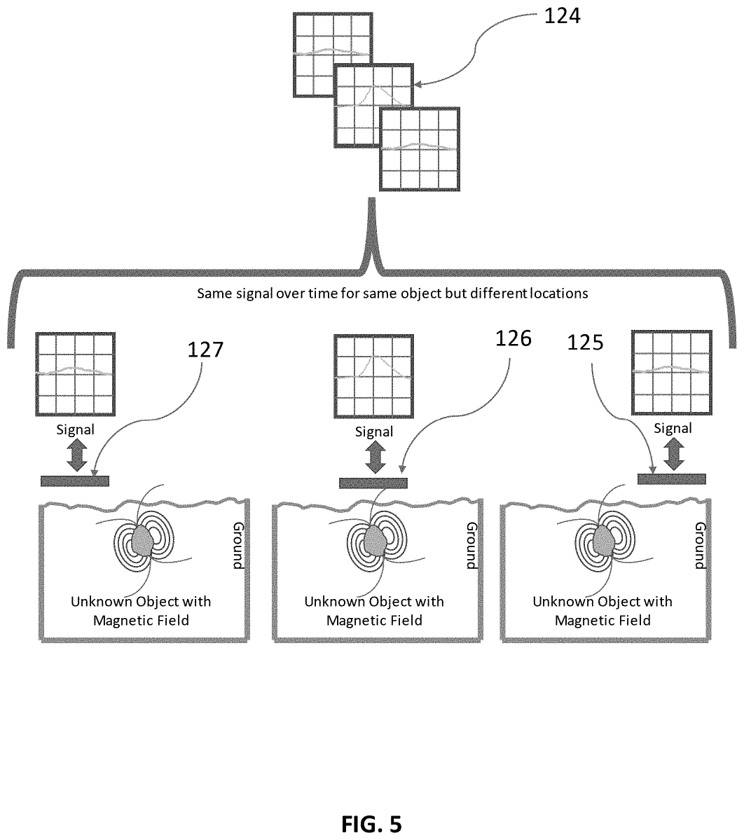

The metal detector can have an array 111 of 3-axis magnetic sensors that create magnetic ‘pixels’ 112 within a reference magnetic field image 113. Each pixel can consist of a field orientation and strength at a given coordinate 112, 114. The grid can be made up of the sensors fixed to a grid having spacing that is millimeters apart, centimeters apart, or greater distances apart. The spacing can be important to help triangulate a signal from an unknown or known object. As the spacing gaps increase in distance, the emitted signal from the object can fade or deteriorate (e.g., refer to FIG. 5). The difference in field from one sensor (e.g., 126, 127, 128 or all together 124 as depicted in FIG. 5) to the next can help triangulate depth, size, and approximant type of material of the unknown or known object.

The magnetic sensor array can be read in within a limit of the framerate of the sensor array (e.g., frequency of each picture). The framerate, or frames per second, dictates a smallest area (e.g., ground) that the detection device can actually ‘see’ objects. Therefore, the framerate can limit how signals are interpreted. Moreover, the framerate can indicate the fastest full images that can be taken within a time it takes for a sum of all the sensors in the grid to register their data and start another measurement, according to the onboard clock 154. The capture speed can be fast enough to take an image within a relativity short time with respect to movement of the detector head. This ensures that the image was taken at a specific local location, rather than smearing that image out across many local locations 120, as depicted in FIG. 4.

FIG. 4 depicts information from sensors that contributes to a signal processed by a deep neural network of the metal detection system described herein. By capturing several images over a single unknown/known target, all signals from the sensors can be categorized into a group that represents a single target. This group of images can be determined by training an algorithm 115 in machine learning to sort out groups of individual targets.

If two or more target objects exist in a relativity close proximity to one another, the signal may group the number of objects together as a single signal. A trained model can be used to help identify when such a case is happening, however merger of magnetic fields can make it challenging to separate each object as a separate and distinct object. Regardless, approximate size, depth, and type(s) of objects, or conglomerate objects (e.g., one signal can show multiple objects but not quite identify each object individually), can be determined.

An accelerometer 123 (e.g., refer to the accelerometer 146 in FIG. 2A) helps the metal detection system determine an acceleration and/or velocity of the detector head. An accelerometer 123 inertial measurement unit (IMU) can be advantageous to improve the metal detection system's ability to identify and determine signals. The action of moving a coil or loop of wire or a detector head through a magnetic field can induce a voltage in the coil. The magnitude of this induced voltage can be proportional to a speed or velocity of the movement. In other words, the faster the detector moves, the more induced voltage can be detected. More magnetic field corresponds to more current that can be detected. Moreover, every material can have a limit to how rapid a magnetic response can be.

Strength of the magnetic field (B-field) can be inversely proportional to a distance between field lines. It can be proportional to a number of lines per unit area that is perpendicular to the field lines. Therefore, the further away the object, the less the magnetic field will be felt. The magnetic field lines may not cross and may be unique at every point in space. By having an accelerometer 123 determining speed and/or acceleration at which the detector head is moving, variations or signal discrepancies of the target object can be identified, where such variances or discrepancies are due to the detector head's movement. As shown in FIG. 4, a single object can be represented as a set of sensor readings over time around the object 119. The movement of the head 120 will allow for multiple views of the same object. Each view made up from the independent sensors, 116-118, 122, 123 can be used in the neural network 115 (e.g., the neural network 152 in FIG. 2A) to determine information about the object 119.

Additionally or alternatively, the accelerometer's output 123 can be used as feedback to the user. The user may unintentionally be moving the detector head too slow, too fast, and/or too jerky (120). The accelerometer 123 can help provide the user with information about a desired speed for proper detection. This speed can also be customized for each user, within certain limits, thereby allowing some users to move faster or slower as they desire. This can also be used to help different users who use the same detector device to experience similar and consistent results.

This neural network 115 can consist of individual inputs from sensors described herein, making a flattened array of inputs for the deep neural network 115 to process. Each signal can pass through a number of hidden layers within the deep neural network 115. The signals can be sorted by the deep neural network 115 and placed within classes that help identify the signals that are being made. These output resulting classes can include objects such as nails, coins, pop tabs, rings, or any other classifications. Unknown classifications can also be identified and labeled for future use and classification.

In some implementations, the neural network 115 can be a single neural network. In other implementations, the neural network 115 can be multiple neural networks. Multiple neural networks models can be used for specific signals types and/or specific locations. For specific signals, a model can be trained by gathering one object type (e.g., a penny), then training the model for just that object type. This training can program the network to determine whether a signal is from that particular object type. Such training can also be used for detecting individual metal types (e.g., gold or silver), in which the network is trained to detect a signal associated with only one metal type. As for location (e.g., a park), the network can be trained on different signals associated with such different environments or locations. After all, signals can be different depending on whether the user is locating ore at a park versus a mine. Moreover, the network can be trained for a size of object, depth, or best-guessed age of the object in the location it was found. By training and modeling for specific signals, locations, and/or any number of specific object types, the user can set the model to be used in different implementations and use cases.

The method to gather data for the machine learning model (e.g., the neural network 115) involves gathering real signals from the sensors of the metal detector and labeling such signals. A robotic arm, for example, can be used to move the detector head over a target signal over and over in slightly varying orientations, accelerations, and/or heights above the object. Where the object is known and buried in soil or in a target substrate material, the robotic arm can be constantly moved around the object to gather information about the object's signal. Each signal that is sensed or captured can be saved (e.g., in the database 153) and used for further processing to identify information about the object.

FIG. 5 depicts the signal of FIG. 4 over time for an object. If speed and acceleration are known, this information can be corrected and/or accounted for. An amount of time can be inferred by a sweeping motion of the detector head. This same motion can also account for types of soils and/or moisture content of the ground, strengths of magnetic fields, and environmental factors, as described in reference to FIGS. 6A-D.

An approximation of depth and size of the object can also be determined by a ‘sweeping’ view. Sweeps 127, 126, and 125 correspond to a sweep in a single direction. Thus, by moving through a magnetic field of the object, the metal detection system described herein can collect data for each moment in time and use such data as an indicator of a single signal 124.

Moreover, knowing position, orientation, and kinematics of the detector can provide for multiple views over a given area of the target object (e.g., refer to FIGS. 6A-D). All these views 124 of the detector head as it moves across the object can allow for multipole imprints of the objects magnetic field orientation over the area 125-127. This can be indicative of how long the object has been in the ground (e.g., due to the object ‘leaching’ materials into its environment, as depicted in FIG. 6B), potential orientation, and potential discrimination of the object in question (e.g., type of magnetic material comprising the object). Sharpness of the signal of the object can also indicate whether the object has recently occupied that spot or location. Sharpness can also account for types of soils and moisture content of the ground by viewing the sweeping view of the object, as depicted in FIG. 5, strengths of the magnetic fields, and environmental factors. Using machine learning, as described herein, can be advantageous to glean information about the object from such varying data, information, and/or ground configuration(s).

An approximation of the depth and size of the object can also be determined by the sweeping view depicted herein (e.g., refer to FIGS. 4-5). Larger objects can have a more even magnetic configuration (e.g., magnetic field pointing in the same direction) versus smaller objects. In contrast, smaller objects can have a sharp spike of field in question (e.g., a peak signal drops off quickly). Small objects can also have less signal per depth. Large objects can be detected deeper and have more consistency of the field. The magnetic sensor array described herein can pick up the size and depth of the object because the pixels or sensors (e.g., pixels 116 in FIG. 4) on a far edge of the sweeping view can detect slight variants of the magnetic field versus an opposite side of the array. This can help triangulate the size and depth of the object in question.

FIG. 6A depicts a range of atmospheric and environmental factors that can affect the signal. FIG. 6B depicts length of time as a factor that affects the signal. FIG. 6C depicts a range of soil types that affect the signal. FIG. 6D depicts a range of moisture content in soil that affect the signal. Referring to FIGS. 6A-D, temperature can affect electrical properties of various materials 121 (e.g., refer to FIG. 6A). In some implementations, if the temperature is known, the temperature can be corrected and accounted for. In addition, the speed and acceleration of the detector head can affect the signals of the objects 123. Whether the object is newer or older can also affect their electrical properties in the ground and/or in the object itself (e.g., refer to FIG. 6B). For example, a rusted object can have a different signal than an object that is not rusted. The object itself can vary in signal based on oxidation or even orientation in the ground where the object interacts with other mineral content in the ground. Ground types can play a role in changing a signal of similar types of objects. Some soil types include sandy 168 and/or rocky soil 169 (e.g., refer to FIG. 6C). For example, a coin may appear different in varying orientations and/or soil types. Moisture can also play a role. For example, wet ground 171 can equate to different signals of the same object in comparison to dry ground 170 (e.g., refer to FIG. 6D). In such examples, the moisture can be interpolated by a humidity/temperature sensor 144, 145 and automatically adjusted as needed.

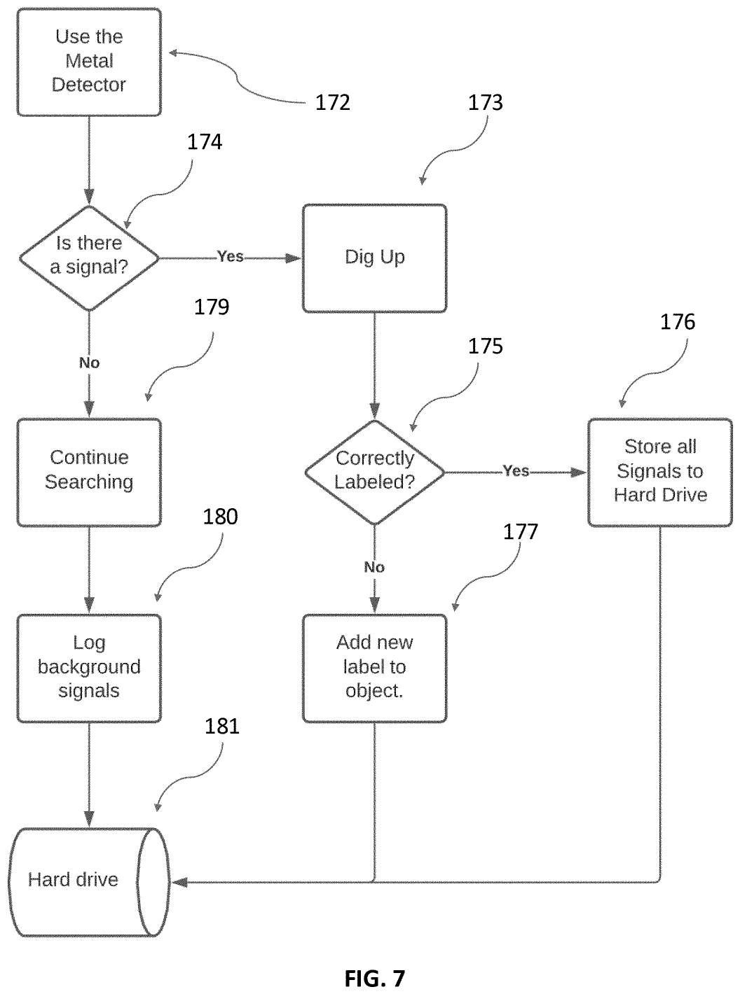

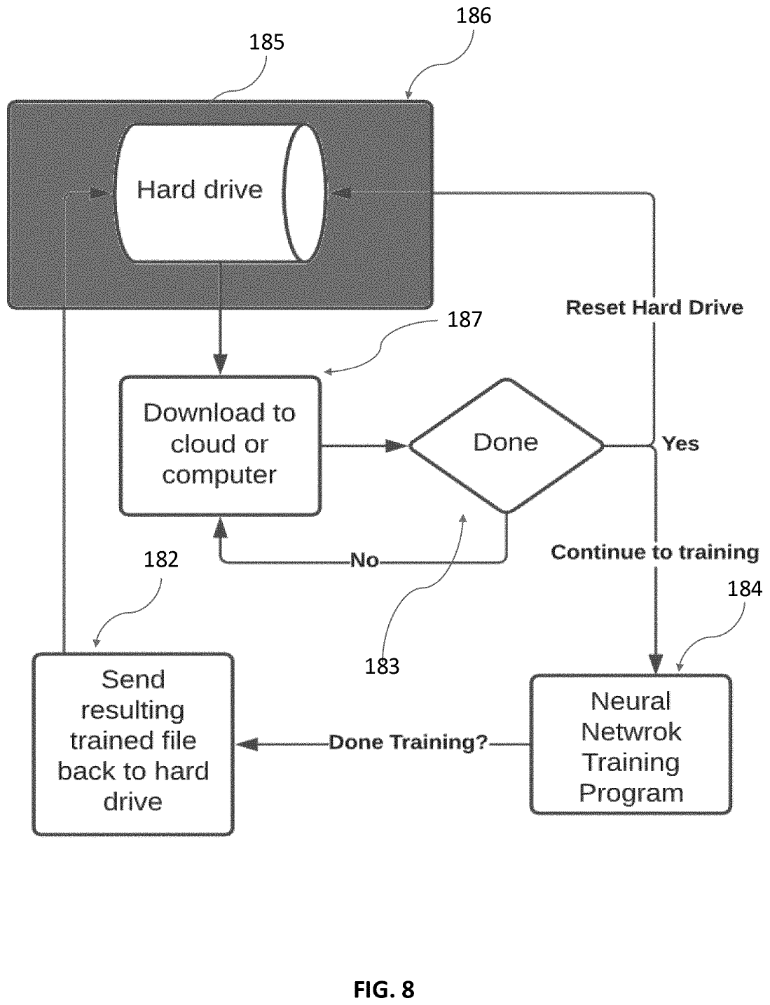

FIG. 7 is a flowchart of a process for using the metal detection system described herein. FIG. 8 is a flowchart of a process for training the metal detection system described herein. In some implementations, a user can find or manufacture a signal for the detector. The user can then move the detector head around a known or unknown signal to gather individual detections of a same object (172). These individual detections can be fed into a database (e.g., the database 153 in FIG. 2A). The user can dig up or identify the object that is being detected. The user can then input into the detector signals after identifying the object via user input controls (e.g., refer to FIG. 2A). Moreover, by use of the IMU (e.g., refer to FIG. 2A), the metal detector system can detect separate signals within close distance to a current signal. In some implementations, the distance can be as little as centimeters apart. The detector system can determine its displacement within some known area and thus can determine when it is targeting a specific object or multiple objects near each other. In some implementations, a n LED light can blink or remain illuminated when the detector is above an individual target. This can help the user to more accurately locate a single signal or multiple signals. It can also help the user identify when coils of the detector are optimally placed above the target. Each user can also determine whether they would like to upload their identified and labeled signals to a common cloud for all users. Sharing this information can be beneficial to improve differing neural network models. This can create a crowdsourced training of the data.

Referring to both processes in the FIGS. 7-8, the user of the metal detector can dig up the unknown object (172-174), identify the object (175-177), and enter the identified object(s) into the system for training at a later time (107, 129, 181). This process can be repeated in order to build a repository of signals of labeled identifications (153, 156, 181). If the user is still searching and no signals are found, background signals can be useful and logged as background (179-181). This labeled identification can then be downloaded from the metal detector, via a USB port (151, 160, 185, 187) or similar connection point, to a computer, the cloud, or a database that can be used to train the deep neural network or machine learning algorithm 184 for higher accuracies 158 and more classification categories. Data in a hard drive 185 located on the detector 186 can be downloaded (187) and trained (184). Results from such training (e.g., machine learning) can be installed on the hard drive 185 of the metal detector 186 (182). The user can decide if they would like to share this data with the full network of all metal detectors or choose to keep it encrypted for his/her own use and training (159).

In some implementations, the metal detection system can be used to find dips in a magnetic field. Most metals create some sort of magnetic field around it, whereas other metals and non-metals can also create a dip or deficiencies in the magnetic field. The detector can identify dips or deficiencies in the magnetic field as a signal. As a result, the system can identify specific types of metals and/or non-metals. For example, information from rocks or cavern/cave walls can be detected and used to identify material(s) comprising the rocks and/or walls. A mix of minerals and other elements can be detected by the detector and used by the metal detection system to provide information about relative mineral or metal makeup. This information can then be used to determine whether the rock or wall has a material that the user desires. Moreover, if the location is accessible with GPS signals, these signals can be used to map areas of mineral content. Moreover, these signals can be used to map where and/or when the mineral content changes. Therefore, the user can more easily identify prime locations for mining minerals and desired elements.

Moreover, the systems and methods described herein can be applied to terrestrial detection or any other body of asteroids, moon, planets, etc., regardless of change in environmental factors. For example, the detection system can be set up to account for changes such as those in a vacuum, on another planet, or on the moon.

What is claimed is:

1. A metal detecting apparatus for detecting metallic objects, the apparatus comprising:
a metal detecting device including a metal detecting sensor configured to provide a signal indicating a presence of a metallic object;
at least one additional sensor that is different from the metal detecting sensor configured to output an additional signal related to detection of the metallic object; and
a controller that is configured to receive the signal from the metal detecting sensor and the additional signal from the at least one additional sensor, wherein the controller is configured to perform operations comprising:
receiving the signals;
interpreting the signals using a trained machine learning model that correlates the signals to a plurality of different types of metallic objects; and
outputting, to a user interface, the detection of the metallic object, wherein the user interface is configured to provide feedback to the user of the detection of the metallic object.

2. The apparatus of claim 1, wherein the at least one additional sensor is a 3-axis sensor configured to generate an image of a local magnetic field of the metallic object, wherein the controller is configured to perform operations further comprising:
receiving the image of the local magnetic field; and
identifying, based on the image of the local magnetic field, the metallic object and based on:
determining a material of the metallic object;
determining a size of the metallic object;
determining a depth of the metallic object; and
labeling the metallic object based on the material, size, and depth.

3. The apparatus of claim 2, wherein labeling the metallic object comprises comparing one or more of the material, size, and depth of the metallic object to machine learning models of labeled objects stored in a database.

4. The apparatus of claim 1, wherein the at least one additional sensor is an accelerometer configured to detect at least one of a speed and a movement of the metal detecting device.

5. The apparatus of claim 1, wherein the at least one additional sensor is a gyroscope configured to detect an orientation of the metal detecting device.

6. The apparatus of claim 1, wherein the at least one additional sensor is a temperature sensor configured to detect a temperature of a surrounding environment of the metal detecting device.

7. The apparatus of claim 1, wherein the at least one additional sensor is a humidity sensor configured to detect a humidity level of a surrounding environment of the metal detecting device.

8. The apparatus of claim 1, wherein the at least one additional sensor is a pressure gauge configured to detect a pressure level in a surrounding environment of the metal detecting device.

9. The apparatus of claim 1, wherein the at least one additional sensor is a location sensor configured to determine coordinates of the metal detecting device in a surrounding environment.

10. The apparatus of claim 9, wherein the controller is configured to perform operations further comprising:
receiving the coordinates of the metal detecting device;
generating a map of the metal detecting device in the surrounding environment;
storing the map in at least one of (i) a database in communication with the controller and (ii) memory of the controller; and
outputting, based on user input received at the user interface, the map for display at the user interface.

11. The apparatus of claim 1, wherein the controller is configured to perform operations further comprising:
classifying the signals of the metallic object using a machine learning model of the metallic object; and
iteratively training the machine learning model of the metallic object based on the classified signals.

12. The apparatus of claim 1, wherein the controller is configured to perform operations further comprising:
receiving user input of a frequency of the signal from the metal detecting device; and
classifying the signal from the metal detecting device based on the user input and the trained machine learning model.

13. The apparatus of claim 1, wherein the controller is configured to perform operations further comprising outputting a classification of the metallic object to the user interface.

14. The apparatus of claim 1, wherein the trained machine learning model is a deep neural network.

15. The apparatus of claim 1, wherein the controller is configured to perform operations further comprising storing, in a database, at least one of (i) a classification of the metallic object, (ii) a classified signal from the metal detecting device, and (iii) a classified additional signal from the at least one additional sensor.

16. The apparatus of claim 1, wherein the controller is configured to perform operations further comprising classifying metallic objects based on signals from the metal detecting device of the metallic object in a plurality of different surrounding environments.

17. The apparatus of claim 1, wherein the controller is configured to perform operations further comprising classifying the metallic object based on user input, wherein the user input includes at least one of a current location of the metal detecting device or an identification label of at least one metallic object.

18. The apparatus of claim 1, wherein the at least one additional sensor is at least one of a 3-axis sensor, an accelerometer, a gyroscope, a temperature sensor, a humidity sensor, a pressure gauge, or a location sensor.

19. The apparatus of claim 1, wherein the at least one additional senor comprises a 3-axis sensor, an accelerometer, a gyroscope, a temperature sensor, a humidity sensor, a pressure gauge, and a location sensor.

20. The apparatus of claim 1, wherein the user interface is in communication with the controller and configured to provide haptic feedback, a display, or audio output of the detection of the metallic object.
